(19) United States
(12) Patent Application Publication
(10) Pub. No.: US 2025/0279110 A1
(43) Pub. Date: Sep. 4, 2025

(54) AUDIO NOISE REDUCTION METHOD, AUDIO NOISE REDUCTION MODEL TRAINING METHOD, AND ELECTRONIC DEVICE

(71) Applicant: Shenzhen Reolink Technology Co., Ltd., Shenzhen (CN)

(72) Inventors: Zhongsi Zhang, Shenzhen (CN); Qingjie Chen, Shenzhen (CN); Yanchong Chai, Shenzhen (CN); Peiyong Yao, Shenzhen (CN)

(21) Appl. No.: 19/213,003

(22) Filed: May 20, 2025

(30) Foreign Application Priority Data
May 21, 2024 (CN) 202410637150.7

(51) Int. Cl. G10L 21/0232; G06N 3/0455; G06N 3/08; G10L 25/30

(52) U.S. Cl. CPC G10L 21/0232; G06N 3/0455; G06N 3/08; G10L 25/30

(57) ABSTRACT

This application provides an audio noise reduction method, an audio noise reduction model training method, and an electronic device. In the audio noise reduction method, a frequency domain audio is obtained by converting an audio to be noise-reduced from time domain to frequency domain frame by frame. The concatenated features of the frequency domain audio are generated by performing an amplitude concatenation for each frame of the frequency domain audio and a phase concatenation for each frame. The concatenated features are putted into an audio noise reduction model to obtain a signal mask, and then the signal mask is processed to obtain a noise-reduced audio. By implementing the audio noise reduction method, the effect of audio noise reduction is improved, and the structure of the noise reduction model is simplified.

### TECHNICAL FIELD

This application relates to the technical field of audio processing, and more particularly, to an audio noise reduction method, an audio noise reduction model training method, and an electronic device.

### BACKGROUND

Audio noise reduction refers to a series of signal processing techniques that reduce or remove noise components from audio signals to improve audio quality and clarity. Early audio noise reduction technologies primarily employed traditional digital signal processing methods, including spectral subtraction and Wiener filtering method. In spectral subtraction, it is necessary to estimate the spectral characteristics of noise and subtract the estimated noise spectrum from the signal spectrum, thereby reducing noise components in the audio. The Wiener filtering method achieves noise reduction by minimizing the mean squared error between the signal and noise. Based on temporal variation characteristics, noise can be classified into stationary noise (e.g., machine background noise, white noise) and non-stationary noise (e.g., wind noise, electric motor rotation sounds). Traditional digital signal processing-based audio noise reduction methods cannot effectively suppress non-stationary noise. During processing, they leave residual noise that significantly impacts auditory perception and may suppress non-noise signals, causing audio distortion.

With the development of artificial intelligence technologies, deep learning-based audio signal processing methods have gradually emerged. Deep learning is a multi-layer representation learning method that transforms input from previous layers into abstract representations containing high-level semantic information through nonlinear transformations, thereby learning complex mapping relationships between inputs and labels. Deep learning-based audio noise reduction technology uses depth neural network models to learn signal characteristics and noise statistical patterns, thereby removing noise and restoring clean audio signals. Currently used depth neural network models typically have excessively large sizes and complex structures, while most embedded platforms impose clear restrictions on the size and structure of depth neural network models, which prevents existing depth neural network models from being deployed on certain embedded terminals and fails to meet portability or real-time requirements.

### SUMMARY

In view of the aforementioned problems, the present application provides an audio noise reduction method, an audio noise reduction model training method, and an electronic device, which are used for solving the problems of causing audio distortion and being unable to be integrally deployed at a partially embedded terminal.

In one aspect, the present application provides an audio noise reduction method which includes: converting an audio to be noise-reduced from time domain to frequency domain frame by frame to obtain a frequency domain audio; performing an amplitude concatenation for each frame of the frequency domain audio and phase concatenation for each frame to generate concatenated features; inputting the concatenated features into an audio noise reduction model to: perform an amplitude feature extraction and a phase feature extraction for each of the concatenated features to obtain first frequency domain noise-reduced features, perform a feature extraction on each of the first frequency domain noise-reduced features to obtain second frequency domain noise-reduced features, and perform an amplitude feature reconstruction and a phase feature reconstruction for each of the second frequency domain noise-reduced features to obtain a noise-reduced signal mask; and processing the noise-reduced signal mask to obtain a noise-reduced audio.

In an alternative, the audio noise reduction model comprises an encoder module, a recurrent neural network layer, and a decoder module. The encoder module comprises a first encoder, a second encoder and a third encoder connected in cascade, each encoder comprising a first convolutional layer, a first normalization layer, a first activation layer, a second convolutional layer, a second normalization layer and a second activation layer connected in cascade. The decoder module comprises a first decoder, a second decoder and a third decoder connected in cascade, each decoder comprising a first transposed convolutional layer, a third normalization layer, a third activation layer, a second transposed convolutional layer, a fourth normalization layer and a fifth activation layer connected in cascade. The recurrent neural network layer is a long short-term memory network.

In an alternative, the encoder module performs the amplitude feature extraction and the phase feature extraction for each of the concatenated features by sliding a window operation on each of the concatenated features in both dimensions of frame length and frame number for an amplitude channel and a phase channel using a two-dimensional convolution. The recurrent neural network layer performs the feature extraction on each of the first frequency domain noise-reduced features according to temporal context information of the first frequency domain noise-reduced features. The decoder module performs the amplitude feature reconstruction and the phase feature reconstruction for each of the second frequency domain noise-reduced features by sliding a window operation on each of the second frequency domain noise-reduced features in both the dimensions of the frame length and frame number for the amplitude channel and the phase channel using a two-dimensional transposed convolution.

In an alternative, the performing an amplitude concatenation for each frame of the frequency domain audio and phase concatenation for each frame to generate concatenated features comprises: performing amplitude concatenation for each frame of the frequency domain audio in both the frame length and the frame number to obtain an amplitude feature map, wherein the length of the amplitude feature map is the frame length and the width of the amplitude feature map is the frame number; performing phase concatenation for each frame of the frequency domain audio in both the frame length and the frame number to obtain a phase feature map, wherein the length of the phase feature map is the frame length and the width of the phase feature map is the frame number; and performing channel concatenation on the amplitude feature map and the phase feature map to generate the concatenated features.

In an alternative, the processing the noise-reduced signal mask to obtain a noise-reduced audio comprises: performing element-wise multiplication of the noise-reduced signal mask with the concatenated features to obtain amplitude and phase of each noise-reduced frame; converting the amplitude and phase of each noise-reduced frame from the frequency domain to the time domain frame by frame to obtain time domain data of each noise-reduced frame; and performing weighted averaging on overlapping portions between adjacent frames of the time domain data of each noise-reduced frame to obtain the noise-reduced audio that is continuous in time domain.

In an alternative, the audio noise reduction method further comprises: acquiring a target noise reduction level; determining a first weight and a second weight corresponding to the target noise reduction level according to the target noise reduction level, wherein a sum of the first weight and the second weight equals 1; and mixing the noise-reduced audio and the audio to be noise-reduced according to the first weight and the second weight respectively to obtain the noise-reduced audio.

In another aspect, the present application provides an audio noise reduction model training method, comprising: constructing a sample dataset comprising a plurality of labeled noisy audios, the labels being clean audios corresponding to the noisy audios; converting the noisy audios from time domain to frequency domain frame by frame to obtain frequency domain noisy audios; performing amplitude concatenation for each frame of the frequency domain noisy audios and phase concatenation for each frame to generate concatenated features; inputting the concatenated features into a depth neural network to: perform an amplitude feature extraction and a phase feature extraction for each of the concatenated features to obtain first frequency domain noise-reduced features, perform a feature extraction on the first frequency domain noise-reduced features to obtain second frequency domain noise-reduced features, and perform an amplitude feature reconstruction and a phase feature reconstruction on each of the second frequency domain noise-reduced features to obtain a noise-reduced signal mask; processing the obtained noise-reduced signal mask to obtain a noise-reduced audio; and optimizing, based on the noise-reduced audio and the clean audio, the parameters of the depth neural network via a loss function to obtain an audio noise reduction model.

In an alternative, the depth neural network comprises an encoder module, a recurrent neural network layer, and a decoder module. The encoder module performs the amplitude feature extraction and the phase feature extraction for each of the concatenated features by sliding a window operation on each of the concatenated features simultaneously in both dimensions of frame length and frame number for an amplitude channel and a phase channel using a two-dimensional convolution. The recurrent neural network layer performs the feature extraction on each of the first frequency domain noise-reduced features according to temporal context information of each of the first frequency domain noise-reduced features. The decoder module performs the amplitude feature reconstruction and the phase feature reconstruction on each of the second frequency domain noise-reduced features by sliding a window operation on each of the second frequency domain noise-reduced features simultaneously in both the dimensions of the frame length and the frame number for the amplitude channel and the phase channel using a two-dimensional transposed convolution.

In an alternative, the constructing a sample dataset comprises: acquiring a plurality of clean audios, a plurality of room impulse responses, and a plurality of noise data; randomly selecting a clean audio, a room impulse response, and noise data from the plurality of clean audios, the plurality of room impulse responses, and the plurality of noise data; performing convolution on the clean audio and the room impulse response to obtain a reverberant audio; mixing the reverberant audio and the noise data at a random signal to noise ratio to obtain a noisy audio; and generating the sample dataset based on the plurality of noisy audios.

In an alternative, the optimizing, based on the noise-reduced audio and the clean audio, the parameters of the depth neural network via a loss function to obtain an audio noise reduction model comprises: determining a mean squared error loss of frequency domain amplitudes between the noise-reduced audio and the clean audio; determining a signal to noise ratio loss between the noise-reduced audio and the clean audio; calculating a multi-resolution STFT auxiliary loss between the noise-reduced audio and the clean audio, wherein the multi-resolution STFT auxiliary loss comprises a spectral convergence loss and a logarithmic time-frequency transform amplitude loss; calculating a weighted sum of the mean squared error loss, the signal to noise ratio loss, and the multi-resolution STFT auxiliary loss to obtain a target loss; and optimizing parameters of the depth neural network according to the target loss to obtain the audio noise reduction model.

According to yet another aspect of the present application, there is provided an electronic device including a memory, a processor, and a computer program stored on the memory, where the processor executes the computer program to implement the audio noise reduction method described above or the audio noise reduction model training method described above.

The above description provides only an overview of the technical solution of the present application. To enable a clearer understanding of the technical means of the present application, implementation can be carried out according to the contents of the specification. Furthermore, in order to make the aforementioned and other objectives, features, and advantages of the present application more apparent and easier to understand, specific the embodiments of the present application are particularly exemplified below.

### BRIEF DESCRIPTION OF THE DRAWINGS

The drawings are only for purposes of illustrating the embodiments and are not to be construed as limiting the present application. Moreover, like reference numerals designate like parts throughout the several views. In the drawings:

FIG. 1 is a schematic diagram showing an application scenario according to an embodiment of the present application;

FIG. 2 is a flow chart showing an audio noise reduction model training method according to an embodiment of the present application;

FIG. 3 is a schematic structural diagram showing a depth neural network according to an embodiment of the present application;

FIG. 4 is a flow chart of constructing and training an audio noise reduction model according to an embodiment of the present application;

FIG. 5 is a flow chart showing an audio noise reduction method according to an embodiment of the present application; and

FIG. 6 is a schematic structural diagram showing an electronic device according to an embodiment of the present application.

### DETAILED DESCRIPTION OF THE INVENTION

Exemplary embodiments of the present application will be described in more detail below referring to the accompanying drawings. While the drawings show exemplary embodiments of the present application, the present application may be embodied in various forms and should not be construed as limited to the embodiments set forth herein.

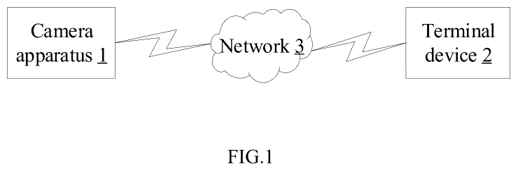

FIG. 1 is a schematic diagram showing an application scenario according to an embodiment of the present application. The camera apparatus 1 establishes a communication connection with a terminal device 2 via a network 3. The camera apparatus 1 may be a camera for security monitoring, an IP camera or other video recording monitoring devices. The terminal device 2 may be a touch-sensitive mobile phone, a smart mobile phone, a tablet computer, a portable terminal device, or other terminal electronic apparatus with a display screen. The network 3 includes, but is not limited to, one or more of a local area network (LAN), a metropolitan area network (MAN), a wide area network (WAN), a 4G/5G network, a WIFI, a Bluetooth, and a point-to-point (P2P) communication network.

In an embodiment of the present application, the camera apparatus 1 and the terminal device 2 may each include one or more processors, which may be a central processing unit CPU, or an Application Specific Integrated Circuit (ASIC), or one or more integrated circuits configured to implement the embodiment, which is not limited herein. The terminal device 2 may include one or more processors, which may be of the same type, such as one or more CPUs; it may also be a different type of processor, such as one or more CPUs and one or more ASICs, which is not limited herein.

The camera apparatus 1 is installed in an area to be monitored (e.g., home, office, shopping mall, etc.) so that the camera apparatus 1 can take a monitoring video recording in the monitored area and transmit the captured video recording to the terminal device 2 via the network 3 for a user to browse.

The video captured by the camera apparatus 1 usually contains audio and video images. In order to ensure the accurate capture of key information to improve the monitoring effect, reduce the false alarm or missing alarm of audio analysis triggering alarm, and adapt to different background noise environments, it is necessary to perform noise reduction in the video captured by the camera apparatus 1, and effectively remove the background noise while retaining the non-noise details.

The embodiments of the present application perform audio noise reduction using a trained audio noise reduction model, where the audio noise reduction model is obtained through depth neural network training. First, an audio noise reduction model training method used by an embodiment of the present application will be described.

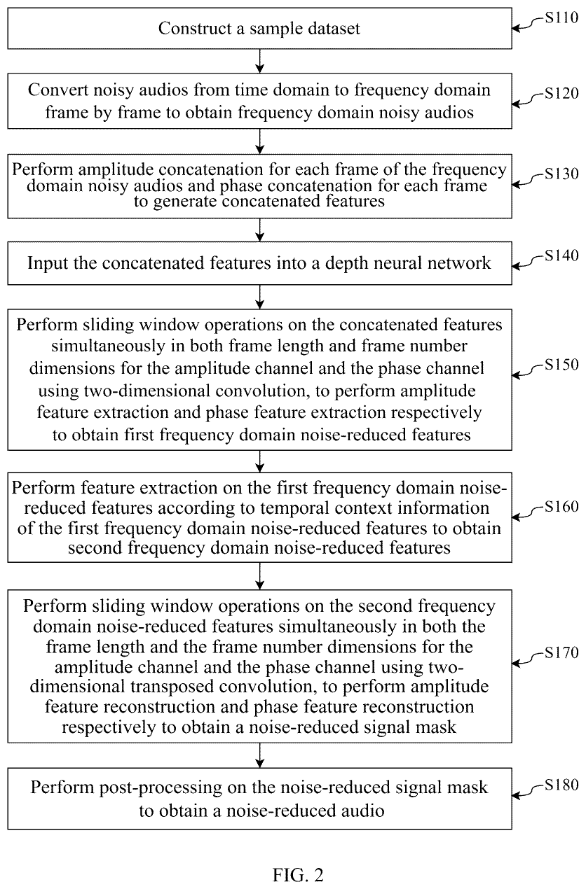

FIG. 2 shows a flow diagram of an audio noise reduction model training method according to an embodiment of the present application, and the method can be executed by an electronic device such as a computer, a server, etc. for noise reduction of any type of audio, noise reduction of individual audio, or noise reduction of audio in video. For example, when reducing noise of the audio in the video captured by the camera apparatus 1, the audio noise reduction model trained by the electronic device can be transplanted to the camera apparatus 1 or the terminal device 2 to reduce noise of the audio in the video. As shown in FIG. 2, the method includes the steps of:

Step S110: construct a sample dataset. The sample dataset includes a plurality of labeled noisy audios, the labels being clean audios corresponding to the noisy audios;

The sample dataset needed for training is constructed before the depth neural network is trained. The data in the constructed sample dataset can be divided into a training group for learning model parameters, a verification group for adjusting model configuration and preventing overfitting, and a test group for evaluating the final performance of the model. Dividing the datasets as described above ensures that the model not only performs well on training data, but also generalizes to unseen data.

In some embodiments, step S110 specifically includes the steps of:

Step a1: Acquire a plurality of clean audios, a plurality of room impulse responses, and a plurality of noise data.

The clean audio, room impulse responses, and noise data obtained in this step may originate from open source data or be acquired through the camera apparatus 1. For example, video data from the camera apparatus 1 may be captured in a quiet environment, from which the device's intrinsic background noise data is separated, and the separated intrinsic background noise data serves as noise data, while the video data with the device's intrinsic background noise data removed is taken as the clean audio. In the embodiments of the present application, the clean audio is not limited to human voice, but may also include alarm sounds, music, bird calls, insect sounds, rain noise, and traffic sounds, etc. Compared to methods using only clean human voice as labels, these embodiments prevent distortion of non-noise signals beyond human speech by adapting to practical application scenarios' definitions of noise versus non-noise signals. Furthermore, when acquiring noise data, specific noise categories may be selected according to actual application scenarios, thereby supporting customized noise classification, which enables suppression of particular noise while preserving other non-noise signals.

Step a2: a clean audio sᵣ a room impulse response r, and noise data n are randomly selected from the plurality of clean audios, the plurality of room impulse responses, and the plurality of noise data.

This step cleans up interfering signals from the audio data, such as audio, room impulse response and noise data, and cuts the audio data into fixed-length segments (e.g., 15 s). The clean audio and noise data shall be respectively according to a:b:c proportions (e.g., 12:3:1) are randomly grouped into training, verification and test groups.

Step a3: the clean audio s and the room impulse response r are performed convolution to obtain a reverberant audio sᵣ.

For the training group, verification group and test group, the clean audio s, the noise data n and the room impulse response r are randomly selected for processing, so that the resulting noisy audio can simulate the real environment. In step a3, the reverberant audio sᵣ is obtained by convolving the clean audio s and the room impulse response r to add reverberation to the clean audio s. For example, the reverberant audio S is obtained by Formula 1:

$${s}_{r} = FFT convolve ( s , r ) \qquad Formula 1$$

Formula 1 convolves the clean audio s (i.e., the original audio signal) with the room impulse response r (i.e., the reverberation response) using a FFTconvolve function to generate a reverberant audio sᵣ to which a reverberation effect is added.

Step a4: the reverberant audio sᵣ and the noise data n are mixed at a random signal to noise ratio to obtain a noisy audio y.

In this step, Formula 2 to Formula 4 can be used to obtain the noisy audio y:

$$Crms = \sqrt{\frac{1}{M} {\sum }_{m = 1}^{M} {s}_{r} \cdot {s}_{r}} \qquad Formula 2$$

$$Nrms = \sqrt{\frac{1}{M} {\sum }_{m = 1}^{M} n \cdot n} \qquad Formula 3$$

$$y = \frac{Crms \cdot Nrms}{{10}^{snr / 20}} \cdot n + {s}_{r} \qquad Formula 4$$

Formulas 2 and 3 calculate the Root Mean Square (RMS) of the reverberant audio sᵣ and the noise data n, respectively. Formula 4 sets a noise level based on a given signal to noise ratio snr, and adds a root mean square characteristic Crms of the reverberant audio sᵣ and the root mean square characteristic Nrms of the noise data n to obtain a noisy audio y. Where M represents the number of samples of the reverberant audio sᵣ and the noise data n.

Step a5: a training dataset is generated based on the plurality of noisy audios y.

The noisy audio y is taken as sample data and the corresponding clean audio s is taken as label, in this way, a training dataset, a verification dataset and a test dataset are generated, which are used for model training and test.

By implementing custom noise and clean audio through steps a1 to a5, the trained model can suppress the specified noise while retaining the non-noise signal.

Step S120: convert noisy audios from time domain to frequency domain frame by frame to obtain frequency domain noisy audios.

During the model training, a fixed number of samples are randomly selected from the training dataset and the verification dataset to constitute the training group and the verification group, respectively. The data will be processed by the pre-processing module, the depth neural network and the post-processing module to obtain the noise reduction output.

In step S120, before performing time frequency conversion on the noisy audio and clean audio, the audio data may first be segmented into frames with a fixed size and offset. Frame division divides a long-term time domain signal into multiple short-term time domain frames, facilitating independent processing of each frame, more effective analysis of the characteristics of the audio signal, extraction of useful features, and improved processing efficiency. After the frame division, a window function (e.g., a Hanning window, a Hamming window) is applied frame by frame to the audio data to achieve signal smoothing, reducing the amplitude of overlapping portions between frames and thereby minimizing audio discontinuities.

Since the representation of audio signals in the frequency domain allows for easier analysis of their frequency components, which is crucial for understanding noise characteristics in the signal. In the frequency domain, specific frequency components can be more effectively separated or extracted to isolate clean audio from background noise. Additionally, the time-varying characteristics of the signal can also be analyzed in the frequency domain. Thus, the present step converts the audio data from the time domain to the frequency domain. Converting the noisy and clean audios from the time domain to the frequency domain can be accomplished by Fourier transform. The audio data converted to the frequency domain can be used to extract the amplitude and phase information of each frame.

Step S130: perform amplitude concatenation for each frame of the frequency domain noisy audios and phase concatenation for each frame to generate concatenated features.

The size of amplitude feature and phase feature of each frame in frequency domain noisy audio is [data batch, amplitude/phase, frame length, frame number], and the size of feature after concatenation and merging is [data batch, 2, frame length, frame number], where 2 represents amplitude channel and phase channel. The frame length is information in the frequency dimension, which represents the number of frequency samples in the frequency domain, in relation to the size of the Fourier transform. The frame number is information of a time dimension, and the frame number of each frame is 1.

The dimensions of the concatenated feature include a data batch, a feature channel, a frame length and a frame number. The feature channel includes an amplitude channel and a phase channel. That is to say, after information about each frame is concatenated, four dimensional features are obtained, and the four dimensions respectively represent a data batch (if the verification is a verification batch, and the test is a test batch), a feature channel (amplitude and phase), a frame length and a frame number. The dimensions of the training/verification/test batch are determined by step S110, which affects the model training and convergence speed; the feature channel, frame length and frame number dimension features are learned by the depth neural network and used to extract the relevant feature representation, where the feature channel is formed after concatenation, and the frame length and frame number are obtained after Fourier transform.

Step S130 specifically includes the steps of:
step b1: each frame of the frequency domain noisy audio in both the dimensions of the frame length and the frame number is performed amplitude concatenation to obtain an amplitude feature map, where the length of the amplitude feature map is the frame length and the width of the amplitude feature map is the frame number;
step b2: each frame of the frequency domain noisy audios in both the dimensions of the frame length and the frame number is performed phase concatenation to obtain a phase feature map, where the length of the phase feature map is the frame length and the width of the phase feature map is the frame number; and
step b3: the amplitude feature map and the phase feature map are performed channel concatenation and data batches are added to the concatenated characteristics of each channel to generate the concatenated features.

The concatenated feature obtained from step S130 includes two feature channels: the amplitude channel and the phase channel, and the concatenated feature includes four dimensions, such as a data batch, a feature channel, a frame length and a frame number, as separate dimensions, where the feature channel, the frame length and the frame number are used for feature learning of the depth neural network, so as to improve the noise reduction effect.

Through steps b1 to b3, the frame length and frame number are respectively used as the length and width of the amplitude feature map and the phase feature map, so that the depth neural network can learn the feature representation of two dimensions of the frame length (frequency domain) and the frame number (time domain) at the same time, which not only improves the learning efficiency, but also ensures the model performance.

The aforementioned steps S110 to S130 are processing steps of a pre-processing module. The raw data is converted by pre-processing into a format suitable for input to the neural network model, so that the model can be more efficiently learned and generalized.

Examples: in image processing, pre-processing may include normalization, clipping, flipping, rotation, etc. In audio processing, resampling, noise reduction, silence detection, etc. may be included.

The concatenated feature obtained from step S130 is used as an input of the depth neural network, and the clean audio is used as an input of the target loss function.

Step S140: input the concatenated features into a depth neural network.

The depth neural network includes an encoder module, a recurrent neural network layer and a decoder module.

Step 150: perform, by the encoder module, sliding window operations on the concatenated features simultaneously in both dimensions of the frame length and the frame number for the amplitude channel and the phase channel using two-dimensional convolution, to perform amplitude feature extraction and phase feature extraction respectively to obtain first frequency domain noise-reduced features.

Step S160: perform, by the recurrent neural network layer, feature extraction on the first frequency domain noise-reduced features according to temporal context information of the first frequency domain noise-reduced features to obtain second frequency domain noise-reduced features.

Step S170: perform, by the decoder module, sliding window operations on the second frequency domain noise-reduced features simultaneously in both the dimensions of the frame length and the frame number for the amplitude channel and the phase channel using two-dimensional transposed convolution, to perform amplitude feature reconstruction and phase feature reconstruction respectively to obtain a noise-reduced signal mask.

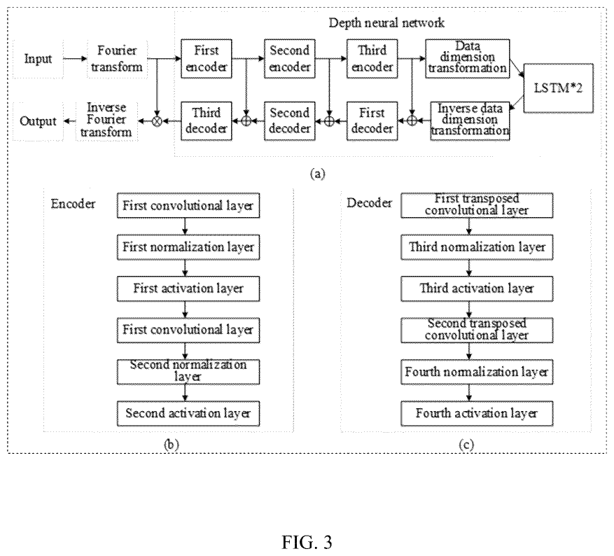

FIG. 3 is a schematic structural diagram showing a depth neural network according to an embodiment of the present application; where (a) is a schematic structural diagram showing a depth neural network, (b) is a schematic structural diagram showing an encoder, and (c) is a schematic structural diagram showing a decoder. With reference to FIG. 3, in an embodiment of the present application, the encoder module includes a first encoder, a second encoder and a third encoder connected in cascade, each encoder including a first convolutional layer, a first normalization layer, a first activation layer, a second convolutional layer, a second normalization layer and a second activation layer connected in cascade; the decoder module includes a first decoder, a second decoder and a third decoder connected in cascade, each decoder including a first transposed convolutional layer, a third normalization layer, a third activation layer, a second transposed convolutional layer, a fourth normalization layer and a fourth activation layer connected in cascade.

As shown in the figure, the encoder module includes 18 layers, and the structure thereof is as follows: convolutional layer 1→normalization layer 1→activation layer 1→convolutional layer 2→normalization layer 2→activation layer 2→convolutional layer 3→normalization layer 3→activation layer 3→convolutional layer 4→normalization layer 4→activation layer 4→convolutional layer 5→normalization layer 5→activation layer 5→convolutional layer 6→normalization layer 6→activation layer 6.

The number of convolution kernels in the convolutional layers 1 to 6 can be respectively set as 16, 16, 32, 32, 64, and 64; the convolution kernel sizes are respectively set as 5×1, 3×1, 3×1, 3×1, 3×1, and 3×1; the step sizes are all set as 2×1; a Rectified Linear Unit (ReLU) is used for activation layers as an activation function; and Batch Normalization (BN) is used for all the normalization layers.

The recurrent neural network layer may employ a Long Short Term Memory Networks (LSTM), such as a 2-layer LSTM, with a hidden layer size of 192 each. The Long Short Term Memory Networks can learn long-term dependence, avoid gradient disappearance and gradient explosion caused by traditional Recurrent Neural Network (RNN), and have good generalization performance.

The decoder module includes 18 layers, and the structure thereof is as follows: transposed convolutional layer 1→normalization layer 7→activation layer 7→transposed convolutional layer 2→normalization layer 8→activation layer 8→transposed convolutional layer 3→normalization layer 9→activation layer 9→transposed convolutional layer 4→normalization layer 10→activation layer 10→transposed convolutional layer 5→normalization layer 11→activation layer 11→transposed convolutional layer 6→normalization layer 12→activation layer 12.

The number of convolution kernels in the transposed convolutional layer 1 to the transposed convolutional layer 6 can be set to 64, 32, 32, 16, 16, 2, respectively, the convolution kernel sizes are set to 3×1, 3×1, 3×1, 3×1, 3×1, 5×1, respectively, and the step sizes are all set to 2×1. The number of convolution kernels of the convolutional layer 7 is set to 2, the convolution kernel size is set to 1×1, and the step size is set to 1. ReLU activation function is used in the activation layer 7 to the activation layer 12, and BN normalization method is used in the normalization layer.

Steps S140 to S170 specifically include:
step c1: the concatenated features are input into a first encoder and are performed feature extraction successively via the first encoder, a second encoder and a third encoder respectively obtain a first feature, a second feature and a third feature, and the third feature is input into a long short-term memory network after performing data dimension transformation to obtain a fourth feature;

The input data of the long short-term memory network is usually sequence data, and the output of the third encoder is the aforementioned four-dimensional data; therefore, it is necessary to perform data dimension transformation on the output of the third encoder and then input the long short-term memory network;
step c2: the fourth feature is performed inverse data dimension transformation and is added with the third feature element by element to obtain a fifth feature, and the first five features are input into a first decoder to perform feature reconstruction so as to obtain a first reconstructed feature;
step c3: the first reconstructed feature and the second feature are added element by element to obtain a sixth feature which is input into a second decoder for feature reconstruction to obtain a second reconstructed feature; and
step c4: the second reconstructed feature and the first feature are added element by element to obtain a seventh feature which is input into a third decoder to perform feature reconstruction so as to obtain a noise-reduced signal mask.

The two-dimensional convolution can be achieved by the following formula:

$$( f \times g ) ( x , y ) = {\sum }_{s = - a}^{a} {\sum }_{t = - b}^{b} f ( s , t ) \times g ( x - s , y - t ) \qquad Formula 5$$

Where f is the input amplitude or phase feature (usually represented as a two-dimensional matrix in a computer), g is the convolution kernel (also a two-dimensional matrix), (x, y) is the position of an element in the output feature, s, t is the position of an element in the convolution kernel, a, b is the half-size of the convolution kernel.

If the amplitude, phase and frequency are mixed into one-dimension, one-dimensional convolution modeling will lead to complex structure and large size of the model, which is not conducive to improve the real-time performance of the model and integration on embedded terminals. In steps S130 to S170, the amplitude and the phase are divided into different feature channels, and combine two-dimensional convolution in the depth neural network to perform feature extraction on the two feature channels of the amplitude and phase, so as to facilitate fitting the corresponding amplitude and phase respectively, simplify the structure of the audio noise reduction model obtained by training, compress the size of the audio noise reduction model, improve the real-time performance of the model, make the audio noise reduction model easier to be integrated in the embedded terminal, and meet the requirements of the embedded terminal for transplantation.

In some embodiments, after step S130, further including: a tanh function is used to normalize the concatenated features. By Tanh normalization processing on the output of Fourier transform, the range of eigenvalue domains can be compressed, the model training can be accelerated, and the quantization processing on the embedded terminal can be facilitated.

The normalized concatenated feature is used as the input of the depth neural network. Step S140 specifically includes: the normalized concatenated features are input into the depth neural network, and the noise-reduced audio is obtained according to the output result of the depth neural network.

Step S180: perform post-processing on the noise-reduced signal mask to obtain a noise-reduced audio.

The output of the depth neural network is converted by a post-processing module into a form required by an end-user or downstream tasks. Step S180 specifically includes:
Step d1: The noise-reduced signal mask is performed element-wise multiplication with the concatenated features to obtain amplitude and phase of each noise-reduced frame. The mask output may improve the performance and generalization of the model by selectively focusing on or ignoring different portions of the data. By multiplying the mask output with the noisy concatenated features, the desired remaining sound can be enhanced while suppressing unwanted noise.
Step d2: the amplitude and phase of each noise-reduced frame are converted from the frequency domain to the time domain frame by frame to obtain time domain data of each noise-reduced frame. Since the final output noise-reduced audio needs to be a time domain signal, this step performs a frequency domain-time domain conversion, which can also be achieved by Fourier transform, and a Hanning window can be added.
Step d3: overlapping portions between adjacent frames of the time domain data of the noise-reduced frames are performed weighted averaging to obtain the noise-reduced audio that is continuous in time domain. In this step, the waveform of the overlapping portion is smoothly superimposed, so that the abrupt sound in audio can be reduced.

Based on the noise-reduced audio and the clean audio, the parameters of the depth neural network via a loss function are optimized to obtain an audio noise reduction model. The loss function in this step is used to measure the difference between the prediction result of the model and the true label, and the loss value of the loss function is usually minimized during the training process, so that the model can better fit the training data and improve the generalization ability of the unseen data. The audio noise reduction model is obtained by optimizing the loss function specifically includes the steps of:
step e1: a Mean Squared Error (MSE) loss of magnitude in the frequency domain is determined for both the noise-reduced audio and the clean audio.

The formula for calculating the mean squared error loss is as follows:

$${L}_{mse} = \frac{1}{M} {‖ \vert S \vert - \vert \hat{S} \vert ‖}_{2} \qquad Formula 6$$

Ŝ is the prediction result (i.e., noise-reduced audio) and S is the label (i.e., clean audio). |S| and |Ŝ| represent a modulus operation, indicating the transformation from the time domain to the frequency domain has been performed. |S| and |Ŝ| can be achieved by step S120 to obtain the amplitude features of the label and the prediction result, and the mean value of the square of the difference between the two, where M represents the prediction result Ŝ and the number of sample points of the label S, and ∥ ∥₂ represents calculating a 2-norm.

Step e2: a signal to noise ratio loss between the noise-reduced audio and the clean audio is determined.

A loss of Signal to Noise Ratio (SNR) of the prediction result Ŝ and the label S is calculated, and the calculation formula is as follows:

$${L}_{snr} = - {log}_{10} ( \frac{\sum {S}^{2}}{\sum {( S - \hat{S} )}^{2}} ) \qquad Formula 7$$

A loss result is obtained by taking a negative value of a logarithmic operation on a ratio of a sum of squares between the clean audio S and the noise signals (S-Ŝ). Formula 7 deals with the unprocessed time domain signal.

Step e3: a multi-resolution STFT auxiliary loss between the noise-reduced audio and the clean audio is calculated, where the multi-resolution STFT auxiliary loss includes a spectral convergence loss and a logarithmic time-frequency transform amplitude loss.

A multi-resolution STFT auxiliary loss (mstft) of the prediction result Ŝ and the label S, and the formula is calculated as follows:

$${L}_{sc} = \frac{{‖ \vert STFT ( S ) \vert - \vert STFT ( \hat{S} ) \vert ‖}_{F}}{{‖ \vert STFT ( S ) \vert ‖}_{F}} \qquad Formula 8$$

$${L}_{mag} = \frac{1}{M} {‖ log \vert STFT ( S ) \vert - log \vert STFT ( \hat{S} ) \vert ‖}_{1} \qquad Formula 9$$

$${L}_{mstft} = {L}_{sc} + {L}_{mag} \qquad Formula 10$$

The multi-resolution STFT auxiliary loss L_{mstft} is composed of two parts: a spectral convergence loss L_{sc} and a logarithmic STFT amplitude loss L_{mag}. Where STFT represents Short-time Fourier Transform, a signal is converted from a time domain to a frequency domain, ∥ ∥F represents calculating an F-norm (Frobenius Norm), ∥ ∥₁ represents calculating a 1-norm, and M represents a prediction result Ŝ and the number of sample points of a label S.

Step e4: a weighted sum of the mean squared error loss, the signal to noise ratio loss, and the multi-resolution STFT auxiliary loss are calculated to obtain a target loss.

The target loss L is a weighted sum of the above three losses, which is expressed as follows:

$$L = α \cdot {L}_{mse} + β \cdot {L}_{snr} + γ \cdot {L}_{mstft} \qquad Formula 11$$

Where α, β and γ represent the weights of the corresponding Lₘₛₑ, Lₛₙᵣ, and L_{mstft}, respectively.

In steps e1 to e4, the post-processed output (noise-reduced audio) and the clean audio are input into a target loss function, and a loss value of the target loss is calculated.

Step e5: parameters of the depth neural network are optimized according to the target loss to obtain the audio noise reduction model.

This step can use a back-propagation algorithm to calculate the gradient of the target loss function to the parameters of the depth neural network, and update the parameters of the depth neural network according to the gradient. Back propagation refers to the calculation of gradient values for each neuron starting from the output layer. The gradient of the output layer is calculated first, and then the gradient of each hidden layer is calculated layer by layer forward until the input layer is reached. The calculation of the gradient is based on a chain rule, where the gradient of the previous layer is multiplied by the derivative of the activation function of the current layer. The gradient update uses the calculated gradient values to update the network parameters, including the weights and offsets of the convolutional layer, the transposed convolutional layer, and the normalization layer.

The target loss and the optimal loss (the initial optimal loss is set as the maximum constant value) are compared in the current training round verification group, and if the current target loss is less than the optimal loss, the current depth neural network weight is saved, and the optimal loss is updated.

The parameters of the depth neural network are optimized by a loss function based on the noise-reduced audio sum, the clean audio and the frequency domain clean audio in steps S110 to S180 are repeatedly executed until the target loss of the verification group is no longer reduced within a specified turn or the training reaches a set maximum turn, and then the training is stopped, and a trained audio noise reduction model is obtained.

The embodiment of the present application employs a depth neural network model including an encoder module, recurrent neural network layer, and decoder module as the audio noise reduction model, which is capable of reducing distortion in non-noise signals and improving audio quality. By converting both the noisy audio from the sample dataset and its corresponding clean audio label from the time domain to the frequency domain to extract amplitude and phase features, and performing separate amplitude concatenation and phase concatenation for each frame of the noisy audio, concatenated features are obtained. The concatenated features contain two feature channels: an amplitude channel and a phase channel, and include four dimensions: data batch, feature channels, frame length, and frame number. These four dimensions serve as independent dimensions, with the feature channels, frame length, and frame number all being utilized for feature learning by the depth neural network to enhance noise reduction performance. By separating the amplitude and phase into distinct feature channels and performing feature extraction on both amplitude and phase channels in the depth neural network using two-dimensional convolution, the network can separately fit the corresponding amplitude and phase features, which simplifies the structure of the trained audio noise reduction model, compresses its size, and makes the model more suitable for integration on embedded terminals.

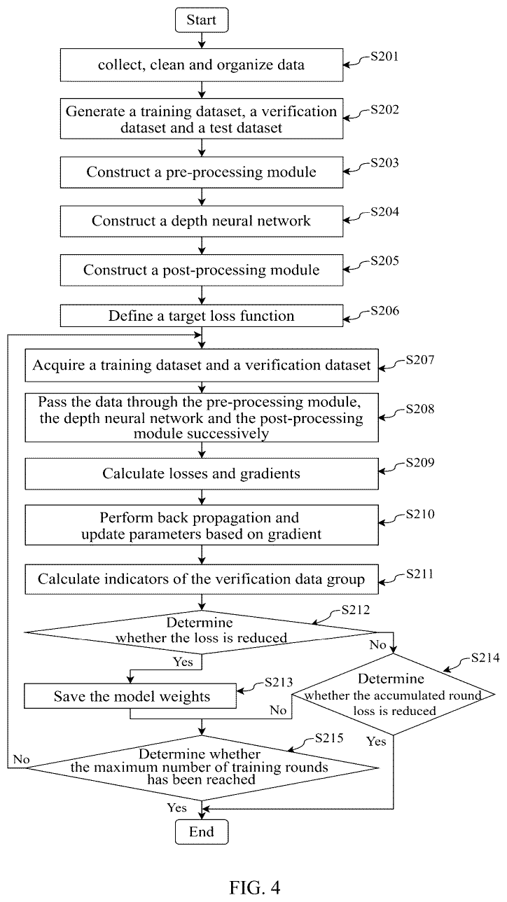

FIG. 4 shows a flow diagram of constructing and training an audio noise reduction model according to an embodiment of the present application, and the flow can be executed by an electronic device such as a computer, a server, etc. for noise reduction of any type of audio, noise reduction of individual audio, or noise reduction of audio in video. For example, when reducing noise of the audio in the video captured by the camera apparatus 1, the audio noise reduction model trained by the electronic device can be transplanted to the camera apparatus 1 or the terminal device 2 to reduce noise of the audio in the video. As shown in FIG. 4, the flow includes the steps of: Step S201: collect, clean and organize data.

This step collects clean audio, room impulse response and noise data from the open source, captures video data from the camera apparatus in a quiet environment, and separates the intrinsic background noise data of the camera apparatus. The interference signal in the data is cleaned, and the data is clipped into segments of 15 s.

Step S202: Generate a training dataset, a verification dataset and a test dataset.

In this step, clean audio and noise data are randomly divided into training, verification and test groups according to a ratio of 12:3:1. For each group of data, the clean audio, noise data and room impulse response are randomly selected, the clean audio and room impulse response are convolved to add reverberation to the clean audio to obtain the reverberant audio, and the reverberant audio and noise data are mixed according to the random signal to noise ratio to obtain the noisy audio. In this way, a training dataset, a verification dataset and a test dataset are generated for model training and testing, using noisy audios as training data and corresponding clean audio as labels.

Step S203: a pre-processing module is constructed. This step constructs the pre-processing module for performing frame division, conversion from time domain to frequency domain, feature concatenation and normalization processing on audio data. The output of the pre-processing module serves as the input to the depth neural network, the target loss function, and the post-processing module. The specific processing steps of the pre-processing module are described with reference to the aforementioned steps S120 to S130.

Step S204: Construct a depth neural network. In this step, a depth neural network composed of three parts: an encoder module, a recurrent neural network layer and a decoder module is constructed, and for the specific structure, reference can be made to FIG. 3.

Step S205: construct a post-processing module. In this step, a post-processing module that calculates the mask output on the output of the depth neural network model is constructed, the mask output is multiplied with the input, then the data from the frequency domain is converted to the time domain for signal smoothing processing.

Step S206: Define a target loss function. The target loss function is defined in Formulas 6 through 11.

Step S207: acquire a training dataset and a verification dataset. In this step, a training dataset and a verification dataset is acquired from the generated training dataset, verification dataset and test dataset generated in step S202.

Step S208: pass the data through the pre-processing module, the depth neural network and the post-processing module successively.

In this step, the data in the training dataset and verification dataset is successively processed by the pre-processing module, the depth neural network and the post-processing module, and the specific processing procedure is described with reference to the embodiment shown in FIG. 2. The specific processing steps of the pre-processing module are described with reference to the aforementioned steps S120 to S130. The detailed processing steps of the depth neural network are described with reference to the aforementioned steps S150 to S170. The specific processing steps of the post-processing module are referred to as the aforementioned step S180. Finally, the noise-reduced audio is obtained.

Step S209: calculate losses and gradients. This step calculates the loss and gradient between the noise-reduced audio and the label (clean audio). For specific processing steps, see steps e1 to e4 described above.

Step S210: Perform back propagation and update parameters based on gradient. The specific process of this step is described in the aforementioned step e5.

Step S211: calculate indicators of the verification data group.

Step S212: determine whether or not the loss is reduced, and if so, step S213 is executed, and if not, step S214 is executed.

Step S213: Save the model weights. Then, step S215 is executed.

Step S214: determine whether or not the accumulated round loss is reduced, and if so, the flow ends, and if not, step S215 is executed.

Step S215: determine whether or not the maximum number of training rounds has been reached, and if so, the flow is ended, and if not, the flow returns to step S207.

In steps S211 to S215, the target loss and the optimal loss (the initial optimal loss is set as the maximum constant value) are compared in the current training round verification group, and if the current target loss is less than the optimal loss, the current depth neural network weight is saved, and the optimal loss is updated. Until the target loss of the verification group is no longer reduced within a specified turn or the training reaches a set maximum turn, and then the training is stopped, and a trained audio noise reduction model is obtained.

The specific implementation and principles of the above steps and with reference to the embodiments shown in FIGS. 2-3 will not be described in detail here.

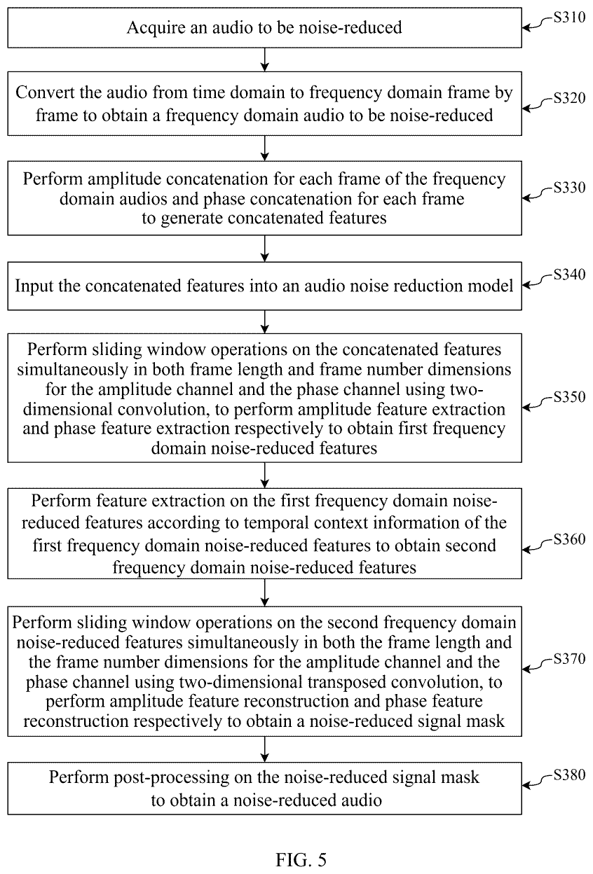

FIG. 5 is a flow chart showing an audio noise reduction method according to an embodiment of the present application; the method can be executed by the camera apparatus 1 described above, and the camera apparatus 1 directly reduces noises of the audios in the captured video recording and outputs the noise-reduced audio; the method can also be executed by an electronic device (for example, a terminal device 2), where the terminal device 2 performs noise reduction on audio in the video acquired from the camera apparatus 1; because of its compact structure, small size, good real-time characteristics, the method is especially suitable for integration into various embedded platforms. An audio noise reduction model used by an embodiment of the present application is trained by the method of the aforementioned embodiment. For the steps in the present embodiment which are the same as or similar to those in the embodiment shown in FIGS. 2 to 3, reference can be made to the foregoing description, and the detailed implementation and advantageous effects thereof will not be described in detail in the present embodiment. As shown in FIG. 5, the process includes the steps of:

Step S310: acquire an audio to be noise-reduced. In the embodiment of the present application, the audio to be noise-reduced can be audio data acquired from the camera apparatus 1, and can also be audio data stored in the terminal device 2, and the source of the audio to be noise-reduced is not specifically defined in the present application.

Step S320: convert the audio to be noise-reduced from time domain to frequency domain frame by frame to obtain a frequency domain audio to be noise-reduced.

Step S330: perform amplitude concatenation for each frame of the frequency domain audios to be noise-reduced and phase concatenation for each frame to generate concatenated features. Dimensions of the concatenated features include feature channels, frame length and frame number, the feature channels including an amplitude channel and a phase channel.

Where step S330 specifically includes the steps of:
step f1: each frame of the frequency domain audio to be noise-reduced in both the dimensions of the frame length and the frame number is performed amplitude concatenation to obtain an amplitude feature map, where the length of the amplitude feature map is the frame length and the width of the amplitude feature map is the frame number;
step f2: each frame of the frequency domain audio to be noise-reduced in both the dimensions of the frame length and the frame number is performed phase concatenation to obtain a phase feature map, where the length of the phase feature map is the frame length and the width of the phase feature map is the frame number; and
Step f3: the amplitude feature map and the phase feature map are performed channel concatenation to generate the concatenated features.

Step S340: input the concatenated features into an audio noise reduction model.

Where the audio noise reduction model is a depth neural network model including an encoder module, a recurrent neural network layer and a decoder module.

Step S350: perform, by the encoder module, sliding window operations on the concatenated features simultaneously in both the dimensions of the frame length and frame number for the amplitude channel and the phase channel using two-dimensional convolution, to perform amplitude feature extraction and phase feature extraction respectively to obtain first frequency domain noise-reduced features.

Step S360: perform, by the recurrent neural network layer, feature extraction on the first frequency domain noise-reduced features according to temporal context information of the first frequency domain noise-reduced features to obtain second frequency domain noise-reduced features.

Step S370: perform, by the decoder module, sliding window operations on the second frequency domain noise-reduced features simultaneously in both the dimensions of the frame length and the frame number for the amplitude channel and the phase channel using two-dimensional transposed convolution, to perform amplitude feature reconstruction and phase feature reconstruction respectively to obtain a noise-reduced signal mask.

The encoder module includes a first encoder, a second encoder and a third encoder connected in cascade, each encoder including a first convolutional layer, a first normalization layer, a first activation layer, a second convolutional layer, a second normalization layer and a second activation layer connected in cascade; the decoder module includes a first decoder, a second decoder and a third decoder connected in cascade, each decoder including a first transposed convolutional layer, a third normalization layer, a third activation layer, a second transposed convolutional layer, a fourth normalization layer and a fifth activation layer connected in cascade; and the recurrent neural network layer is a long short-term memory network.

Where steps S340 to S370 specifically include the steps of:
Step g1: the concatenated features are input into a first encoder and are performed feature extraction successively via the first encoder, a second encoder and a third encoder respectively obtain a first feature, a second feature and a third feature, and the third feature is input into a long short-term memory network after performing data dimension transformation to obtain a fourth feature;
Step g2: the fourth feature is performed inverse data dimension transformation and is added with the third feature element by element to obtain a fifth feature, and the first five features are input into a first decoder to perform feature reconstruction so as to obtain a first reconstructed feature;
Step g3: the first reconstructed feature and the second feature are added element by element to obtain a sixth feature which is input into a second decoder for feature reconstruction to obtain a second reconstructed feature; and
Step g4: the second reconstructed feature and the first feature are added element by element to obtain a seventh feature which is input into a third decoder to perform feature reconstruction so as to obtain a noise-reduced signal mask.

After step S330, the method further includes: the tanh function is used to normalize the concatenated features. Step S340 specifically includes: the normalized concatenated features are input into the audio noise reduction model.

Step S380: perform post-processing on the noise-reduced signal mask to obtain a noise-reduced audio.

Where step S380 specifically includes the steps of:
step h1: the noise-reduced signal mask is performed element-wise multiplication with the concatenated features to obtain amplitude and phase of each noise-reduced frame;
step h2: the amplitude and phase of each noise-reduced frame are converted from the frequency domain to the time domain frame by frame to obtain time domain data of each noise-reduced frame; and
step h3: overlapping portions between adjacent frames of the time domain data of the noise-reduced frames are performed weighted averaging to obtain the noise-reduced audio that is continuous in time domain.

In some embodiments, after step S380, the method further includes the steps of:
Step i1: acquire a target noise reduction level.
Step i2: a first weight and a second weight corresponding to the target noise reduction level are determined according to the target noise reduction level, where a sum of the first weight and the second weight equals 1; and
Step i3: the noise-reduced audio and the audio to be noise-reduced are mixed according to the first weight and the second weight respectively to obtain a target noise-reduced audio.

For example, the calculation formula for the target noise-reduced audio may be:

$${\hat{S}}_{1} = \hat{S} \times {w}_{1} + {\hat{S}}_{0} \times {w}_{2} \qquad Formula 12$$

Where Ŝ₁ a target noise-reduced audio, Ŝ is a noise-reduced audio, Ŝ₀ an audio to be noise-reduced, w₁ is a first weight, and w₂ is a second weight.

In the aforementioned manner, a plurality of groups of selectable first weights and second weights can be set, each group of weights respectively corresponding to a different noise reduction level, and a user can adjust the noise reduction level personalized according to noise reduction requirements, and the model structure does not need to be changed, and also does not need to be retrained, so as to achieve the output of multiple noise reduction effects.

The present application converts the audio to be noise-reduced from the time domain to the frequency domain to extract amplitude and phase features, and performs amplitude concatenation and phase concatenation separately for each frame of the audio to be noise-reduced to obtain concatenated features. The concatenated features include two feature channels: an amplitude channel and a phase channel, and include dimensions such as feature channels, frame length, and frame number. These dimensions serve as independent dimensions and are all utilized by the audio noise reduction model for feature learning, thereby improving the noise reduction performance of the model. By separating the amplitude and phase into different feature channels and performing feature extraction on both the amplitude and phase channels in the audio noise reduction model using two-dimensional convolution, the model can more conveniently fit the corresponding amplitude and phase separately, which simplifies the model structure and compresses the model size, making the embodiments of the present application more suitable for integration on embedded terminals.

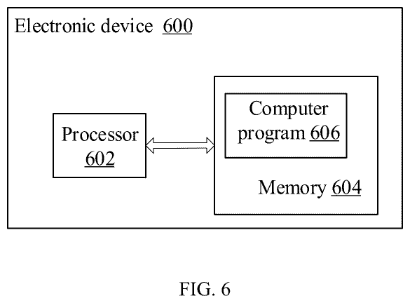

FIG. 6 shows a schematic structural diagram of an electronic device according to an embodiment of the present application, and the specific embodiment of the present application does not limit the specific implementation of the electronic device.

As shown in FIG. 6, the electronic device 600 may be a terminal device 2 as shown in FIG. 1 or may be another electronic apparatus having data processing capabilities. The electronic device 600 includes, but is not limited to, a processor 602 and a memory 604.

The memory 604 is used for storing a computer program 606. The memory 604 may include high-speed RAM memory, and may also include non-volatile memory, such as at least one disk memory. The computer program 606 may include computer-executable instructions.

The processor 602 is configured to execute the computer program 606 to implement the audio noise reduction method embodiment and/or the audio noise reduction model training method embodiment described above.

The processor 602 may be a central processing unit CPU, or an Application Specific Integrated Circuit (ASIC), or one or more integrated circuits configured to implement the embodiments of the present application. The electronic device includes one or more processors, which may be of the same type, such as one or more CPUs; it may also be a different type of processor, such as one or more CPUs and one or more ASICS.

The embodiments of the present application provide a computer-readable storage medium storing a computer program that, when executed by a processor, implements the aforementioned audio noise reduction method embodiment or audio noise reduction model training method embodiment.

The embodiments of the present application provide a computer program that, when executed by a processor, implements the audio noise reduction method embodiment or audio noise reduction model training method embodiment described above.

The embodiments of the present application provide a computer program product that includes a computer program that, when executed by a processor, implements the audio noise reduction method embodiment or the audio noise reduction model training method embodiment described above.

In several embodiments provided herein, any of the functions, if implemented in the form of software functional modules/units and sold or used as a stand-alone product, may be stored in the computer-readable storage medium. Based on such an understanding, all or a portion of the technical aspects of the present application may be embodied in the form of a software product, the computer software product being stored in a storage medium and including instructions for causing a computer device (e.g., an electronic device such as a personal computer, a server, etc.) to perform all or a portion of the steps of a method as described in various the embodiments of the present application. The aforementioned storage medium includes: USB flash disk, removable hard disk, Read-only Memory (ROM), Random Access Memory (RAM), magnetic or optical disk and the like can store computer program code.

The algorithms or displays presented herein are not inherently related to any particular computer, virtual system, or other apparatus. Various general-purpose systems may also be used with the teachings based herein. The structure required to construct such a system is apparent from the above description. Further, the present application is not directed to any particular programming language. It should be understood that the subject matter described herein may be implemented using a variety of programming languages and that the description above of specific languages is for an object of disclosing the best mode of practicing the subject matter.

It should be noted that the aforementioned embodiments illustrate rather than limit the application, and that a person skilled in the art will be able to design alternative embodiments without departing from the scope of the appended claims. In the claims, any reference signs placed between parentheses shall not be construed as limiting the claim. The word “including” does not exclude the presence of elements or steps other than those listed in a claim. The word “a” or “an” preceding an element does not exclude the presence of a plurality of such elements. The application can be implemented by means of hardware including several distinct elements, and by means of a suitably programmed computer. In the claims enumerating several means, several units or modules of these apparatuses can be embodied by one and the same item of hardware. The use of the words first, second, third, etc. does not denote any order. These words may be interpreted as names. The steps in the above embodiments are not to be construed as limiting the order of execution unless otherwise specified.

The embodiments described above represent only a few The embodiments of the present application and are described in more detail and are not to be construed as limiting the scope of the present application. It should be noted that several variations and modifications can be made by a person skilled in the art without departing from the inventive concept, which is within the scope of the present application. Accordingly, the protection sought in the present application is as set forth in the claims below.

What is claimed is:

1. An audio noise reduction method, comprising:
converting an audio to be noise-reduced from time domain to frequency domain frame by frame to obtain a frequency domain audio;
performing an amplitude concatenation for each frame of the frequency domain audio and a phase concatenation for each frame to generate concatenated features;
inputting the concatenated features into an audio noise reduction model to: perform an amplitude feature extraction and a phase feature extraction for each of the concatenated features to obtain first frequency domain noise-reduced features, perform a feature extraction on each of the first frequency domain noise-reduced features to obtain second frequency domain noise-reduced features, and perform an amplitude feature reconstruction and a phase feature reconstruction for each of the second frequency domain noise-reduced features to obtain a noise-reduced signal mask; and
processing the noise-reduced signal mask to obtain a noise-reduced audio.

2. The method according to claim 1, wherein the audio noise reduction model comprises an encoder module, a recurrent neural network layer, and a decoder module.

3. The method according to claim 2, wherein:
the encoder module performs the amplitude feature extraction and the phase feature extraction for each of the concatenated features by sliding a window operation on each of the concatenated features in both dimensions of frame length and frame number for an amplitude channel and a phase channel using a two-dimensional convolution;
the recurrent neural network layer performs the feature extraction on each of the first frequency domain noise-reduced features according to temporal context information of the first frequency domain noise-reduced features; and
the decoder module performs the amplitude feature reconstruction and the phase feature reconstruction for each of the second frequency domain noise-reduced features by sliding a window operation on each of the second frequency domain noise-reduced features in both the dimensions of the frame length and the frame number for the amplitude channel and the phase channel using a two-dimensional transposed convolution.

4. The method according to claim 2, wherein:
the encoder module comprises a first encoder, a second encoder and a third encoder connected in cascade, each encoder comprising a first convolutional layer, a first normalization layer, a first activation layer, a second convolutional layer, a second normalization layer and a second activation layer connected in cascade;
the decoder module comprises a first decoder, a second decoder and a third decoder connected in cascade, each decoder comprising a first transposed convolutional layer, a third normalization layer, a third activation layer, a second transposed convolutional layer, a fourth normalization layer and a fifth activation layer connected in cascade; and
the recurrent neural network layer is a long short-term memory network.

5. The method according to claim 1, wherein the performing an amplitude concatenation for each frame of the frequency domain audio and phase concatenation for each frame to generate concatenated features comprises:
performing amplitude concatenation for each frame of the frequency domain audio in both the frame length and the frame number to obtain an amplitude feature map, wherein the length of the amplitude feature map is the frame length and the width of the amplitude feature map is the frame number;
performing phase concatenation for each frame of the frequency domain audio in both the frame length and the frame number to obtain a phase feature map, wherein the length of the phase feature map is the frame length and the width of the phase feature map is the frame number; and
performing channel concatenation on the amplitude feature map and the phase feature map to generate the concatenated features.

6. The method according to claim 1, wherein the processing the noise-reduced signal mask to obtain a noise-reduced audio comprises:
performing element-wise multiplication of the noise-reduced signal mask with the concatenated features to obtain amplitude and phase of each noise-reduced frame;
converting the amplitude and phase of each noise-reduced frame from the frequency domain to the time domain frame by frame to obtain time domain data of each noise-reduced frame; and
performing weighted averaging on overlapping portions between adjacent frames of the time domain data of each noise-reduced frame to obtain the noise-reduced audio that is continuous in time domain.

7. The method according to claim 1, further comprising:
acquiring a target noise reduction level;
determining a first weight and a second weight corresponding to the target noise reduction level according to the target noise reduction level, wherein a sum of the first weight and the second weight equals 1; and
mixing the noise-reduced audio and the audio to be noise-reduced according to the first weight and the second weight respectively to obtain the noise-reduced audio.

8. An audio noise reduction model training method, comprising:
constructing a sample dataset comprising a plurality of labeled noisy audios, the labels being clean audios corresponding to the noisy audios;
converting the noisy audios from time domain to frequency domain frame by frame to obtain frequency domain noisy audios;
performing amplitude concatenation for each frame of the frequency domain noisy audios and phase concatenation for each frame to generate concatenated features;
inputting the concatenated features into a depth neural network to: perform an amplitude feature extraction and a phase feature extraction for each of the concatenated features to obtain first frequency domain noise-reduced features, perform a feature extraction on the first frequency domain noise-reduced features to obtain second frequency domain noise-reduced features, and perform an amplitude feature reconstruction and a phase feature reconstruction on each of the second frequency domain noise-reduced features to obtain a noise-reduced signal mask;
processing the obtained noise-reduced signal mask to obtain a noise-reduced audio; and
optimizing, based on the noise-reduced audio and the clean audio, the parameters of the depth neural network via a loss function to obtain an audio noise reduction model.

9. The method according to claim 8, wherein the depth neural network comprises an encoder module, a recurrent neural network layer, and a decoder module.

10. The method according to claim 9, wherein:
the encoder module comprises a first encoder, a second encoder and a third encoder connected in cascade, each encoder comprising a first convolutional layer, a first normalization layer, a first activation layer, a second convolutional layer, a second normalization layer and a second activation layer connected in cascade;
the decoder module comprises a first decoder, a second decoder and a third decoder connected in cascade, each decoder comprising a first transposed convolutional layer, a third normalization layer, a third activation layer, a second transposed convolutional layer, a fourth normalization layer and a fifth activation layer connected in cascade; and
the recurrent neural network layer is a long short-term memory network.

11. The method according to claim 9, wherein:
the encoder module performs the amplitude feature extraction and the phase feature extraction for each of the concatenated features by sliding a window operation on each of the concatenated features simultaneously in both dimensions of frame length and frame number for an amplitude channel and a phase channel using a two-dimensional convolution;
the recurrent neural network layer performs the feature extraction on each of the first frequency domain noise-reduced features according to temporal context information of each of the first frequency domain noise-reduced features; and
the decoder module performs the amplitude feature reconstruction and the phase feature reconstruction on each of the second frequency domain noise-reduced features by sliding a window operation on each of the second frequency domain noise-reduced features simultaneously in both the dimensions of the frame length and the frame number for the amplitude channel and the phase channel using a two-dimensional transposed convolution.

12. The method according to claim 8, wherein the constructing a sample dataset comprises:
acquiring a plurality of clean audios, a plurality of room impulse responses, and a plurality of noise data;
randomly selecting a clean audio, a room impulse response, and noise data from the plurality of clean audios, the plurality of room impulse responses, and the plurality of noise data;
performing convolution on the clean audio and the room impulse response to obtain a reverberant audio;
mixing the reverberant audio and the noise data at a random signal to noise ratio to obtain a noisy audio; and
generating the sample dataset based on the plurality of noisy audios.

13. The method according to claim 8, wherein the optimizing, based on the noise-reduced audio and the clean audio, the parameters of the depth neural network via a loss function to obtain an audio noise reduction model comprises:
determining a mean squared error loss of frequency domain amplitudes between the noise-reduced audio and the clean audio;
determining a signal to noise ratio loss between the noise-reduced audio and the clean audio;
calculating a multi-resolution STFT auxiliary loss between the noise-reduced audio and the clean audio, wherein the multi-resolution STFT auxiliary loss comprises a spectral convergence loss and a logarithmic time-frequency transform amplitude loss;
calculating a weighted sum of the mean squared error loss, the signal to noise ratio loss, and the multi-resolution STFT auxiliary loss to obtain a target loss; and
optimizing parameters of the depth neural network according to the target loss to obtain the audio noise reduction model.

14. An electronic device, comprising:
a memory configured to store a computer program comprising a plurality of instructions;
at least one processor coupled to the memory and configured to execute the instructions stored in the memory to cause the at least one processor to:
convert an audio to be noise-reduced from time domain to frequency domain frame by frame to obtain a frequency domain audio;
perform amplitude concatenation for each frame of the frequency domain audio and phase concatenation for each frame to generate concatenated features;
input the concatenated features into an audio noise reduction model to: perform an amplitude feature extraction and a phase feature extraction for each of the concatenated features to obtain first frequency domain noise-reduced features, perform a feature extraction on each of the first frequency domain noise-reduced features to obtain second frequency domain noise-reduced features, and perform an amplitude feature reconstruction and a phase feature reconstruction for each of the second frequency domain noise-reduced features to obtain a noise-reduced signal mask; and
process the noise-reduced signal mask to obtain a noise-reduced audio.

15. The electronic device according to claim 14, wherein the audio noise reduction model comprises an encoder module, a recurrent neural network layer, and a decoder module.

16. The electronic device according to claim 15, wherein:
the encoder module performs the amplitude feature extraction and the phase feature extraction for each of the concatenated features by sliding a window operation on each of the concatenated features in both dimensions of frame length and frame number for an amplitude channel and a phase channel using a two-dimensional convolution;
the recurrent neural network layer performs the feature extraction on each of the first frequency domain noise-reduced features according to temporal context information of the first frequency domain noise-reduced features; and
the decoder module performs the amplitude feature reconstruction and the phase feature reconstruction for each of the second frequency domain noise-reduced features by sliding a window operation on each of the second frequency domain noise-reduced features in both the dimensions of the frame length and the frame number for the amplitude channel and the phase channel using a two-dimensional transposed convolution.

17. The electronic device according to claim 15, wherein:
the encoder module comprises a first encoder, a second encoder and a third encoder connected in cascade, each encoder comprising a first convolutional layer, a first normalization layer, a first activation layer, a second convolutional layer, a second normalization layer and a second activation layer connected in cascade;
the decoder module comprises a first decoder, a second decoder and a third decoder connected in cascade, each decoder comprising a first transposed convolutional layer, a third normalization layer, a third activation layer, a second transposed convolutional layer, a fourth normalization layer and a fifth activation layer connected in cascade; and
the recurrent neural network layer is a long short-term memory network.

18. The electronic device according to claim 14, wherein the at least one processor further executes the instructions to:
perform an amplitude concatenation for each frame of the frequency domain audio in both the frame length and the frame number dimensions to obtain an amplitude feature map, wherein the length of the amplitude feature map is the frame length and the width of the amplitude feature map is the frame number;
perform phase concatenation for each frame of the frequency domain audio in both the frame length and the frame number dimensions to obtain a phase feature map, wherein the length of the phase feature map is the frame length and the width of the phase feature map is the frame number; and
perform channel concatenation on the amplitude feature map and the phase feature map to generate the concatenated features.

19. The electronic device according to claim 14, wherein the at least one processor further executes the instructions to:
perform element-wise multiplication of the noise-reduced signal mask with the concatenated features to obtain amplitude and phase of each noise-reduced frame;
convert the amplitude and phase of each noise-reduced frame from the frequency domain to the time domain frame by frame to obtain time domain data of each noise-reduced frame; and
perform weighted averaging on overlapping portions between adjacent frames of the time domain data of each noise-reduced frame to obtain the noise-reduced audio that is continuous in time domain.

20. The electronic device according to claim 14, wherein the at least one processor further executes the instructions to:
acquire a target noise reduction level;
determine a first weight and a second weight corresponding to the target noise reduction level according to the target noise reduction level, wherein a sum of the first weight and the second weight equals 1; and
mix the noise-reduced audio and the audio to be noise-reduced according to the first weight and the second weight respectively to obtain the noise-reduced audio.
